(19) United States
(12) Patent Application Publication
(10) Pub. No.: US 2020/0016852 A1
(43) Pub. Date: Jan. 16, 2020

(54) METHOD AND PLANT FOR CONSOLIDATING FIBER COMPOSITE STRUCTURES

(71) Applicant: Dieffenbacher GmbH Maschinen-und Anlagenbau, Eppingen (DE)

(72) Inventors: Klaus Jung, Eppingen (DE); Matthias Graf, Eppingen (DE)

(73) Assignee: Dieffenbacher GmbH Maschinen-und Anlagenbau, Eppingen (DE)

(21) Appl. No.: 16/492,934

(22) PCT Filed: Mar. 14, 2018
(86) PCT No.: PCT/EP2018/056359

§ 371 Date: Sep. 10, 2019

(30) Foreign Application Priority Data
Mar. 14, 2017 (DE) 10 2017 105 450.2

(51) Int. Cl. B29C 70/44; B29C 70/46; B29C 35/08

(52) U.S. Cl. CPC B29C 70/44; B29C 70/46; B29K 2101/12; B29C 2035/0822; B29C 35/0805

(57) ABSTRACT

A method for consolidating a fiber composite structure with at least one thermoplastic and/or thermoelastic polymer includes arranging the structure between a plate-shaped base and a plate-shaped cover in a loading/unloading station of a conveying device. The cover is sealed with respect to the base by a seal to be displaceable in relation to the base. The method includes generating negative pressure in the interstice between the base and the cover so the ambient pressure pushes the cover against the base, the structure being clamped between the cover and the base; heating the composite structure by electromagnetic radiation preferably at least into the range of the melting temperature of the at least one polymer in a heating station, cooling the composite structure in a cooling station of the conveying device; and removing the consolidated structure from the base or removing the base onto which the structure has been placed.

The present invention relates to a method for consolidating fiber composite structures according to claim 1 and to a system for consolidating fiber composite structures according to claim 14 for automotive components, for example.

The applications for fiber composite materials have steadily increased over the past decades, in particular when they could be considered as an inexpensive alternative to metallic materials, offering the advantages of freedom of design and application-specific formulation possibilities. Specifically, the material CFRP (carbon fiber-reinforced polymer) has extremely high lightweight construction potential, being distinguished both by the high strength thereof and very high structural rigidity. The latter is an important criterion, for example, in automobile construction.

The automatable production of the preform represents a key technology in the production process of filament-reinforced fiber composite components to achieve efficient high-volume production with reproducible stable component quality. However, even in the case of so-called hybrid components, that is, compression-molded metal sheets, which are primarily compressed with carbon fiber semi-finished products to additionally reinforce critical load-bearing zones, all production units must be able to be integrated in terms of equipment and control engineering if sufficient productivity is to be achieved.

Nowadays, predominantly textile fiber semi-finished products, such as staple yarns and/or sheet materials (so-called prepregs) wetted with a binder (hot-melt adhesive) and/or partially or completely impregnated with a matrix, such as fiber woven fabrics, fiber knitted fabrics, fiber laid scrims or fiber mats, are used to produce filament-reinforced components. The task of the matrix of fiber-reinforced plastics is to embed the high-strength fibers (supporting function) and completely fill the interstices therebetween (barrier function).

In principle, materials from the groups of thermoplastic resins and possibly additional plasticizing components, such as elastomers, which differ in terms of strength, maximum elongation, usage temperature, processing speed and chemical resistance, can be used as binding and/or matrix materials.

Blanks are produced for example in a cutting process from these semi-finished products, which are available in the form of rolls or sheet goods in standard formats and which generally line the formed component across the entire surface area.

Alternatively, filament-reinforced components can also be produced in a substantially less wasteful or waste-free manner, and thus more resource-efficiently, by methods that became known as fiber placement or tape laying processes. Specifically the use of tapes, comprising preferably unidirectional filaments in a thermoplastic matrix, is proving to be a very attractive process variant. A “tape” in the present context preferably means any kind of web-like material, in particular a prepreg material having, for example, a width between 30 and 200 mm, which is suitable for deposition by means of a tape laying device. In the present case, “prepreg material” means, in particular, filament yarns (rovings), fiber laid scrims and/or fiber woven fabrics which are wetted with a binder and/or partially or completely impregnated, in particular pre-impregnated, with a matrix, for example a thermoplastic matrix. The “fibers” are, in particular, carbon fibers, but similarly can also be used for glass fibers or other, in particular synthetically produced, fibers. For the processing of tapes, it is known to peel these from a reel or roll by means of tape laying devices, in particular also so-called fiber placement devices, to cut them to length, and to deposit them onto a laying table or a tape structure already deposited on the laying table. When a strip of tape is deposited, it is connected in a punctiform manner to the tape layer underneath via a number of ultrasonic welding heads. Exemplary tape laying devices are known, for example, from the documents WO 2014/083196 A1 and U.S. Pat. No. 8,048,253.

After fiber composite structures having a desired shape have been laid or created in this way by laying individual tapes, or by arranging large-surface-area blanks, it is necessary to compress the fiber composite structures in a subsequent method step by applying pressure and heat and thereby consolidate them to form a laminate.

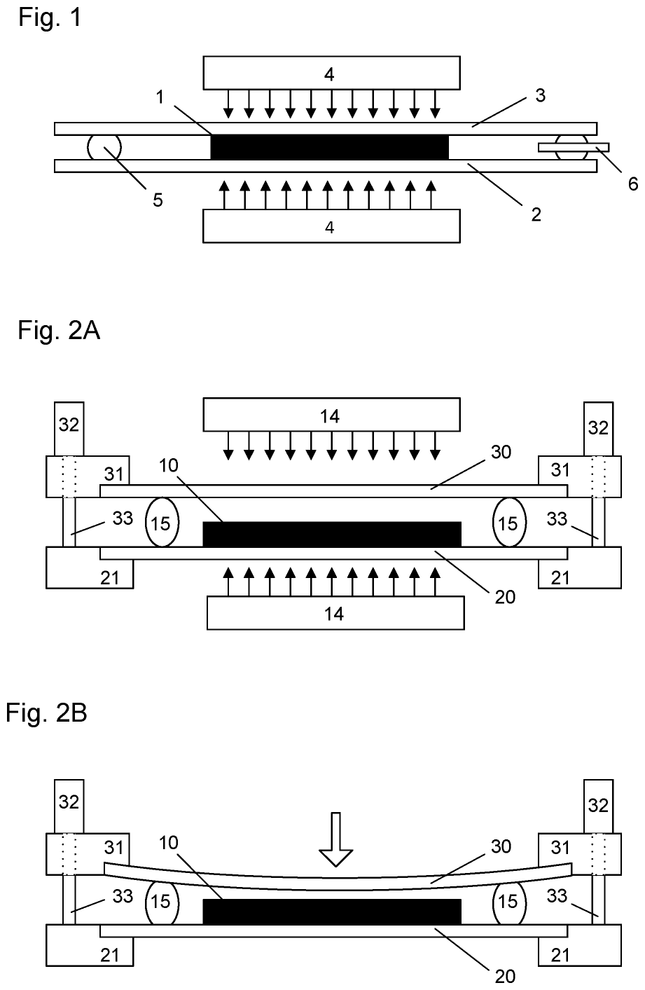

An exemplary method for consolidating fiber composite structures with thermoplastic and/or thermoelastic polymers is known from document DE 10 2014 004 053 A1. In this document, as shown in FIG. 1, it is proposed to arrange a fiber composite structure 1 to be consolidated on a rigid base 2 and to place a rigid cover 3 on the fiber composite structure 1 so that the fiber composite structure 1 is located in a interstice between the base 2 and the cover 3. Laterally, the interstice is sealed by an annular seal 5 made of resilient material. Furthermore, radiation sources 4 are provided, which are arranged above or beneath the cover 3 and the base 2 and generate electromagnetic radiation, in particular infrared radiation. The cover 3 and the base 2 are designed to allow the electromagnetic radiation generated by the radiation sources 4 to pass so that the electromagnetic radiation can be coupled into the fiber composite structure 1, through the base 2 and the cover 3. So as to consolidate the fiber composite structure 1, the fiber composite structure 1 is irradiated with the electromagnetic radiation through the base 2 and the cover 3 in order to convert the impregnating polymer into a plasticized, molten state. In addition, the interstice between the base 2 and the cover 3 is evacuated by means of a vacuum pump (not shown) connected to a pipe socket 6 opening into the interstice, so that the fiber composite structure 1 is compressed between the cover 3 and the base 2, while compressing the annular seal 5, as a result of the ambient pressure acting on the cover 3 from above (or also at least regionally on the base 2 from beneath).

The advantage of this method is the low system complexity that is required, in particular dispensing with pressing tools or the like, so that the method can be implemented in a simple and cost-effective manner. Moreover, the method allows direct heating of the fiber composite structure 1 without the need to heat large pressing tools, for example, which makes the method very energy-efficient and thus cost-effective to operate.

However, the method is not very well-suited for consolidating fiber composite structures using a low cycle time and supplying them immediately to further shaping processes and/or forming processes, in particular if the consolidation is to take place directly after the production of the fiber composite structure, and the consolidated fiber composite structure is to be supplied immediately to a shaping process and/or forming process after consolidation has taken place.

Furthermore, the method is not very well-suited for consolidating fiber composite structures that have local reinforcements, for example in component regions to which hinges are to be later attached, or which are to be connected to other components.

With this method, it is also possible for air inclusions to occur when the cover and base are closed, or for air inclusions to form within the fiber composite structure during compression and consolidation, for example due to the evaporation of adhering residual moisture, and thus for pores to possibly form in the consolidated laminate. Even though a certain degree of venting of the fiber composite structure is ensured by the applied negative pressure, it is possible, since the fiber composite structure is pressed between the base and the cover, that air inclusions or resulting vapor bubbles are only inadequately extracted by suction in some instances, especially in the middle of the fiber composite structure. Consequently, pores can form, especially in the middle of the fiber composite structure, which can result in a visually unsatisfactory appearance of the surface of the consolidated laminate, and/or in an inhomogeneous laminate.

It is therefore an object of the invention to provide a method and a system for consolidating a fiber composite structure which overcomes the above drawbacks.

It is a further object of the invention to provide a method and a system for consolidating a fiber composite structure which allow rapid consolidation and direct further processing of the consolidated fiber composite structure.

It is a further object of the invention to provide a method and a system for consolidating a fiber composite structure which also allow fiber composite structures having local reinforcements to be consolidated with a high quality.

It is still another object of the invention to provide a method and a system for consolidating a fiber composite structure which make it possible to consolidate a fiber composite structure to form a laminate while substantially avoiding the formation of air inclusions and/or pores, thus making it possible to create a laminate having a flawless, homogeneous surface.

These and other objects of the invention are achieved by a method and a device for consolidating a fiber composite structure as indicated in claims 1 and 14. Further preferred embodiments are set out in the dependent claims.

As a first solution, a method for consolidating a fiber composite structure with at least one thermoplastic and/or thermoelastic polymer is proposed, comprising arranging the fiber composite structure between a plate-shaped base and a plate-shaped cover in a loading/unloading station of a conveying device, wherein the cover is sealed with respect to the base by a sealing element so as to be displaceable in relation to the base; generating a negative pressure in the interstice between the base and the cover so that the ambient pressure pushes the cover against the base and the fiber composite structure is clamped between the cover and the base; heating the fiber composite structure by means of electromagnetic radiation preferably at least into the range of the melting temperature of the at least one thermoplastic and/or thermoelastic polymer in a heating station the conveying device; cooling the fiber composite structure in a cooling station of the conveying device; and removing the consolidated fiber composite structure from the base or removing the base onto which the consolidated fiber composite structure has been placed from the conveying device.

This makes it possible to consolidate fiber composite structures directly after a creation process and to be able to further process them directly after being consolidated, resulting overall in a low cycle time. A direct process in a compact system is thus made possible.

After removal from the conveying device, the consolidated fiber composite structure is preferably fed to a press, in particular a stamping press. The consolidated fiber composite structure can thus be brought into a near net shape, and any cut-outs can be produced at a point in time at which the consolidated fiber composite structure is stable but still flexible.

It can also be provided that, after the fiber composite structure has been arranged on the base, the base is lifted out of the conveying device by means of a lifting table and moved toward the cover, and/or the cover is held above the conveying device by means of holding elements and moved toward the base. Precise alignment of the base with respect to the cover can be achieved by the lifting table as well as by the holding elements, since the base including the composite structure and the cover is thereby decoupled from the conveying device, and the base can thus be accordingly oriented with respect to the cover.

As an alternative or in combination, it is provided that the cover is released from the at least one holding element as soon as a negative pressure is built up in the interstice between the base and the cover, and the lifting table deposits the arrangement composed of the base, the cover and the fiber composite structure placed therebetween in the conveying device, preferably in the loading/unloading station. As a result of the negative pressure in the interstice between the cover and the base, the cover and the base are fixed in the their positions relative to one another, and the cover rests on the base via the sealing element.

In a preferred refinement, an identification of bubble formation can be carried out during the compression of the fiber composite structure, wherein in the case of bubble formation, the pressure in the interstice is temporarily increased and/or the cover is lifted to achieve an at least partial reduction in the contact of the cover, in particular a reduction in the contact of the subsection with the fiber composite structure, and thus to enable a local ventilation path for removing the air or vapor. The identification of bubble formation can take place, in particular, by monitoring the magnitude of the negative pressure in the interstice and/or by detecting the temperature distribution in the fiber composite structure by means of a thermographic camera, wherein the presence of a bubble is inferred when a local cold spot identifiable in the thermal image is present relative to a hot surrounding area.

By additionally carrying out bubble identification, the reliability of consolidation can be further improved, and the high grade and quality of a fiber composite structure consolidated and compressed to form the laminate can be ensured.

Sealing can be carried out by means of a sealing element, in particular an elastic annular seal.

It can be provided that the heating of the fiber composite structure is carried out by means of electromagnetic radiation before, concurrently with, or after compressing the fiber composite structure between the cover and the base.

In particular, cooling in the cooling station is carried out by way of a self-contained surface cooling system, in particular a cooling table, wherein the surface cooling system is in contact with the base and/or with the cover. The surface cooling system enables uniform cooling of the entire consolidated fiber composite structure and thus prevents the formation of thermal stresses within the fiber composite structure. Local density differences can also be prevented in this way. In this case, a self-contained cooling system represents a closed system in which, for example, a coolant circulates and which gives off the cooling action via the outside surface of the cooling surface system. It has been shown, in particular, that spraying on a coolant is not practical for systems for the direct processing of fiber composite structures, in particular with respect to the system complexity and the cycle times to be achieved.

Cooling through both the base and the cover is preferred, since this allows uniform as well as rapid cooling of the consolidated fiber composite structure.

Furthermore, it can be provided that the surface cooling system is designed as a cooling table which can lift the arrangement composed of the base, the cover and the fiber composite structure placed therebetween out of the conveying device and supply it to further surface cooling via the cover.

As an alternative or in combination, the method is characterized in that the fiber composite structure is cooled in the cooling station to a temperature which is below the melting temperature and above the softening temperature of the at least one thermoplastic and/or thermoelastic polymer, or which is below the softening temperature of the at least one thermoplastic and/or thermoelastic polymer. The fiber composite structure is preferably cooled in the cooling station to a temperature below 150° C., preferably below 120° C., particularly preferably below 100° C. In this way, the consolidated fiber composite structure becomes manageable and can be fed to further process steps. The ideal temperature depends on the further process steps as well as on the type of the polymer.

The conveying device is preferably designed to be rotatable, in particular in the form of a rotary table. This enables a compact design and short transport distances between the individual stations of the conveying device.

The cover and/or the base are preferably designed as or comprise a glass panel. Furthermore, it can be provided that the fiber composite structure includes at least one region of an elevation, wherein a cavity is provided in the cover for each region of the elevation to receive the corresponding elevation. This also makes it possible to consolidate fiber composite structures having differences in elevations.

In particular, it can further be provided that each cavity surrounds the respectively associated elevation laterally with a gap, wherein the gap preferably has a width between 3 and 15 mm, particularly preferably between 5 and 10 mm.

It can also be provided that each cavity has a depth which is between 0.7 times and 1.0 times the height of the respectively associated elevation compared to the surface of the fiber composite structure in a non-raised region, and/or each cavity has a depth which is dimensioned so as to compensate for the material shrinkage or the compaction of the material of the fiber composite structure during consolidation.

In a preferred refinement, the method can further comprise: causing flection of the cover so that the cover, optionally with additional lowering of the cover, makes contact with the surface of the fiber composite structure in a subsection; and further flection and/or lowering the cover until the cover makes contact with the entire surface of the fiber composite structure, and the fiber composite structure is compressed between the cover and the base.

The compression and consolidation of the fiber composite structure therefore do not take place simultaneously across the entire surface area, as is the case, for example, with the method explained with reference to FIG. 1. Rather, the fiber composite structure is compressed successively and in a controlled manner toward the outside, proceeding from a narrow portion, by means of the bent cover so that the displacement of fiber and polymer material, which is caused by the local action of the compressive force exerted by the bent cover, causes air trapped in the fiber composite structure or vapors forming as a result of heating to be pushed out and, after only a relatively short distance, to reach a region in which the cover, by virtue of the flection thereof, does not yet, or not yet strongly, push on the fiber composite structure, so that the trapped air or vapors forming as a result of heating can escape more easily from the fiber composite structure into the interstice and be removed via the connected vacuum pump. This makes it possible to consolidate the fiber composite structure substantially without or with only a few and very small air inclusions or pores and thus form it into a high-grade laminate of high quality.

Preferably, the cover is initially positioned at a distance above the fiber composite structure. More preferably, the cover only makes contact with the fiber composite structure after the fiber composite structure has already been completely heated to melt the impregnating polymer.

It is preferably provided that the cover comprises a respective support frame element on at least two opposing sides, and/or the base comprises a respective support frame element on at least two opposing sides.

It can be provided that a respective bracing unit is arranged in the region of at least two opposing sides of the cover which each brace the cover with respect to the base so as to counteract a force caused by the negative pressure in the intermediate region and acting in a downward direction on the cover, and thus bring about the flection of the cover.

The bracing units can each be designed as one or more actuators, in particular as pneumatic actuators, hydraulic actuators or electromotive actuators. The use of actuators which can be activated, in particular, by a control units, allows careful and controlled positioning and/or flection of the cover. This can advantageously be supplemented in that the vacuum pump is likewise controlled by the control unit so as to thereby bring about a well-defined and desired pressure state or a pressure curve over the time in the interstice. Particularly preferably, monitoring or measuring of the pressure in the interstice can also take place in the process, so that, if necessary, the control unit is able to carry out a readjustment or correction, and/or in order to trigger monitoring functions.

Alternatively, the bracing units can each be designed as spring elements. In this way, a very simple and cost-effective design can be implemented which also has very good properties. In particular, by selecting or implementing desired suitable spring characteristics, such as the use of degressive spring characteristics, it is possible to set the progression of the flection of the cover and of the consolidation over time according to a desired profile, and thereby achieve desired and customized consolidation and compression. Even though the spring elements alone represent passively acting elements, there is still the option of actively intervening, in particular of controlling and/or regulating the procedure in that, for example, a control unit accordingly controls the operation of the vacuum pump so as to generate the negative pressure in the interstice and thereby raise or lower the prevailing (negative) pressure accordingly, or assigns a desired pressure profile over time, wherein the prevailing negative pressure in combination with the spring characteristics of the spring elements, in turn, results in a corresponding embodiment of the flection of the cover.

Further alternatively, the bracing units can each be designed as spacer elements having a height greater than a target thickness of the fiber composite structure after consolidation.

With this embodiment, a solution is implemented that is as simple as possible, and thus has the least complex design and lowest cost, but nevertheless achieves good results. The spacer elements can be arranged between the fiber composite structure and the sealing element, but are preferably arranged outside the sealing element, thereby resulting in better handling of the spacer elements and allowing these to be replaced without problems to meet the respective needs.

A system for consolidating a fiber composite structure is provided in still another solution, wherein the system comprises a conveying device, comprising a loading/unloading station, a heating station and a cooling station, and the system is configured so as to deposit the fiber composite structure onto a base in the loading/unloading station or introduce a base including a fiber composite structure into the system, and to position a cover over the base and, by means of a vacuum pump, generate a negative pressure in the interstice between the cover and the base, further to move the base and the cover including the fiber composite structure placed therebetween to the heating station, to heat the fiber composite structure in the heating station by means of the at least one radiation source, preferably at least into the range of the melting temperature of the at least one thermoplastic and/or thermoelastic polymer, and, by means of the vacuum pump, to maintain or further increase the negative pressure in the interstice for compressing the fiber composite structure between the cover and the base, to move, after compressing has been completed, the base and the cover including the compressed fiber composite structure placed therebetween to the cooling station and to cool the arrangement composed of the base, the cover and the fiber composite structure placed therebetween in the cooling station; after cooling has been carried out, to move the base and the cover including the fiber composite structure placed therebetween to the loading/unloading station and, in the loading/unloading station, to lift the cover off the base by means of holding elements to remove the consolidated fiber composite structure (from the base, or to remove the base onto which the consolidated fiber composite structure has been placed).

The system preferably further comprises a press, in particular a stamping press. This enables a near net shape and the formation, for example, of cut-outs in the consolidated fiber composite structure directly after consolidation with the fiber composite structure, which is still warm compared to room temperature.

Furthermore, it can be provided that the conveying device is designed as a rotary table.

A lifting table is preferably arranged in the loading/unloading station to move the base, together with the fiber composite structure deposited thereon, away from and toward the conveying device. As an alternative or in combination, a holding element is arranged to hold the cover above the conveying device and to move it toward and away from the base. This allows precise alignment of the base with the cover.

The system can preferably further comprise a sensor for detecting the pressure in the interstice and/or a thermographic camera for detecting an image of the temperature distribution in the fiber composite structure, wherein the system preferably further comprises a control unit configured to determine that a bubble is present upon identification of a sudden rise in pressure or a local cold spot identifiable in the thermal image relative to a hot surrounding area and, when a bubble is present, to instruct the vacuum pump and/or the bracing units designed as actuators to temporarily increase the pressure in the interstice and/or lift the cover, so as to achieve an at least partial reduction in the contact of the cover with the fiber composite structure and thus enable a local ventilation path for removing the air or vapor.

Furthermore, the system is preferably distinguished in that a self-contained surface cooling system, preferably a cooling table, is arranged in the cooling station and can lift the arrangement composed of the base, the cover and the fiber composite structure placed therebetween out of the conveying device and deposit it, and which can achieve a cooling effect through the base, and/or a self-contained surface cooling system, preferably a cooling table, is arranged in the cooling station and can be moved toward the cover and can achieve a cooling effect through the cover.

Preferably, the cover and/or the base are designed as or comprise a glass panel.

The aforementioned system is preferably configured to carry out the methods described herein.

A device for consolidating a fiber composite structure with at least one thermoplastic and/or thermoelastic polymer is provided as still another solution, comprising a plate-shaped base; a plate-shaped cover; a sealing element for displaceably sealing the cover with respect to the base; at least one radiation source for generating electromagnetic radiation for heating the fiber composite structure by means of electromagnetic radiation, preferably at least into the range of the melting temperature of the at least one thermoplastic and/or thermoelastic polymer; and a vacuum pump for generating a negative pressure in the interstice between the base and the cover so that the ambient pressure pushes the cover against the base, and the fiber composite structure is compressed between the cover and the base, wherein the fiber composite structure includes at least one region of an elevation, wherein a cavity is provided in the cover for each region of an elevation to receive the corresponding elevation.

In particular, it can further be provided that each cavity surrounds the respectively associated elevation laterally with a gap, wherein the gap preferably has a width between 3 and 15 mm, particularly preferably between 5 and 10 mm. It can also be provided that each cavity has a depth which is between 0.7 times and 1.0 times the height of the respectively associated elevation compared to the surface of the fiber composite structure in a non-raised region, and/or each cavity has a depth which is dimensioned so as to compensate for the material shrinkage or the compaction of the material of the fiber composite structure during consolidation.

Preferably, the device further comprises bracing units provided in the region of at least two opposing sides of the cover, which are configured to brace the cover with respect to the base so as to counteract a force caused by the negative pressure in the intermediate region and acting in a downward direction on the cover, and thus effectuate flection of the cover.

The bracing units are preferably each designed as one or more actuators, in particular as pneumatic actuators, hydraulic actuators or electromotive actuators or as spring elements, or they are designed as spacer elements having a height greater than a target thickness of the fiber composite structure after consolidation.

The invention will be described hereafter with reference to the drawings:

FIG. 1 shows a method for consolidating a fiber composite structure according to the prior art:

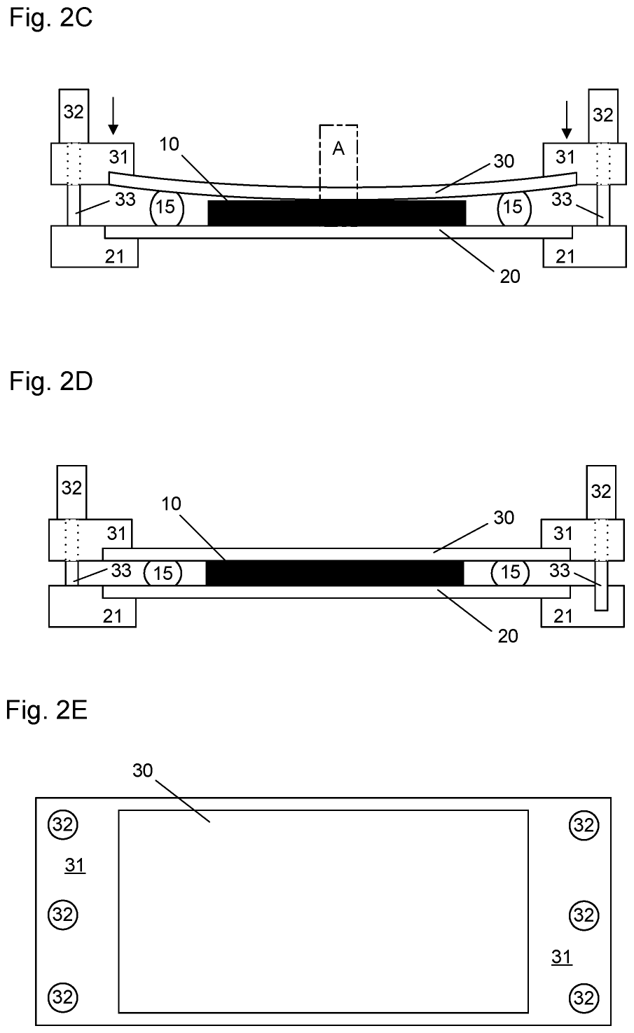

FIGS. 2A to 2E show a method for consolidating a fiber composite structure according to a first preferred embodiment;

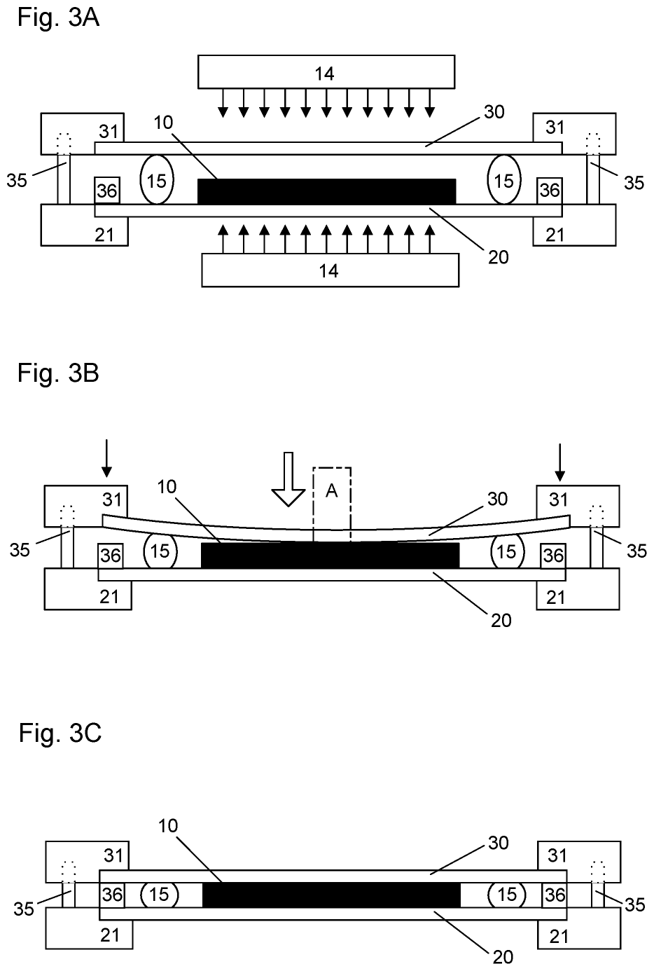

FIGS. 3A to 3C show a method for consolidating a fiber composite structure according to a second preferred embodiment;

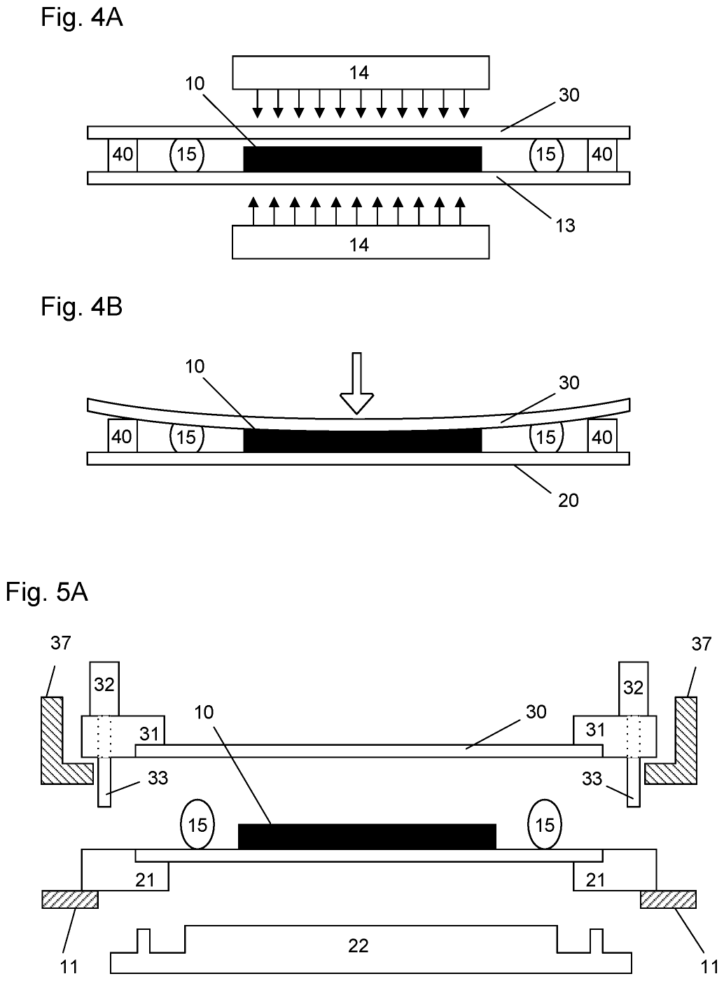

FIGS. 4A and 4B show a method for consolidating a fiber composite structure according to a third preferred embodiment;

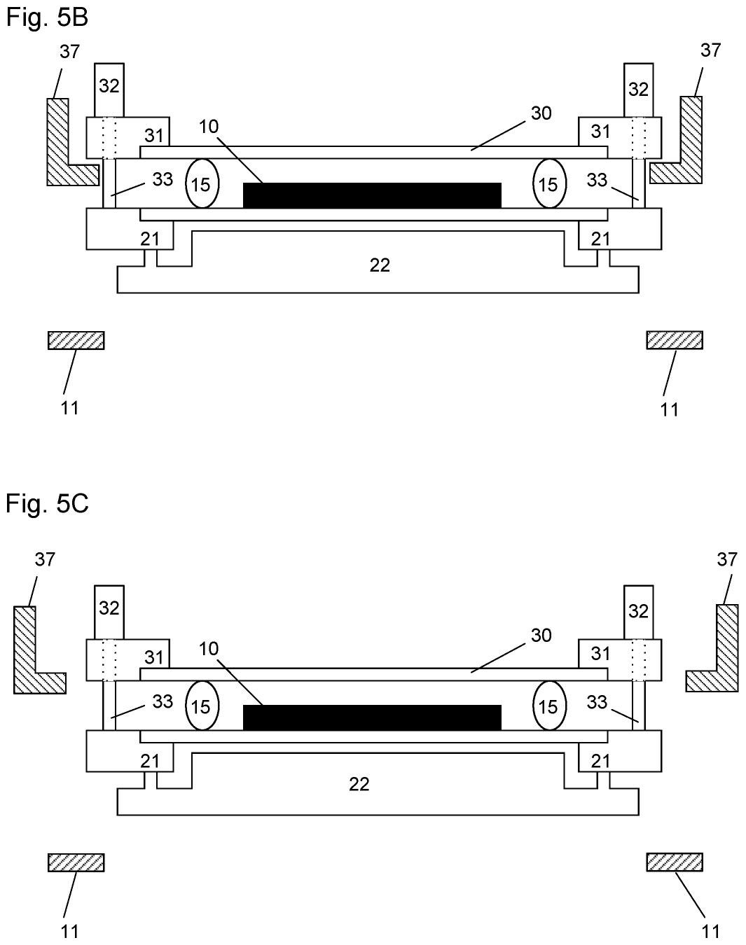

FIGS. 5A to 5E schematically explain a method for consolidating a fiber composite structure having an elevation, according to another preferred embodiment; and

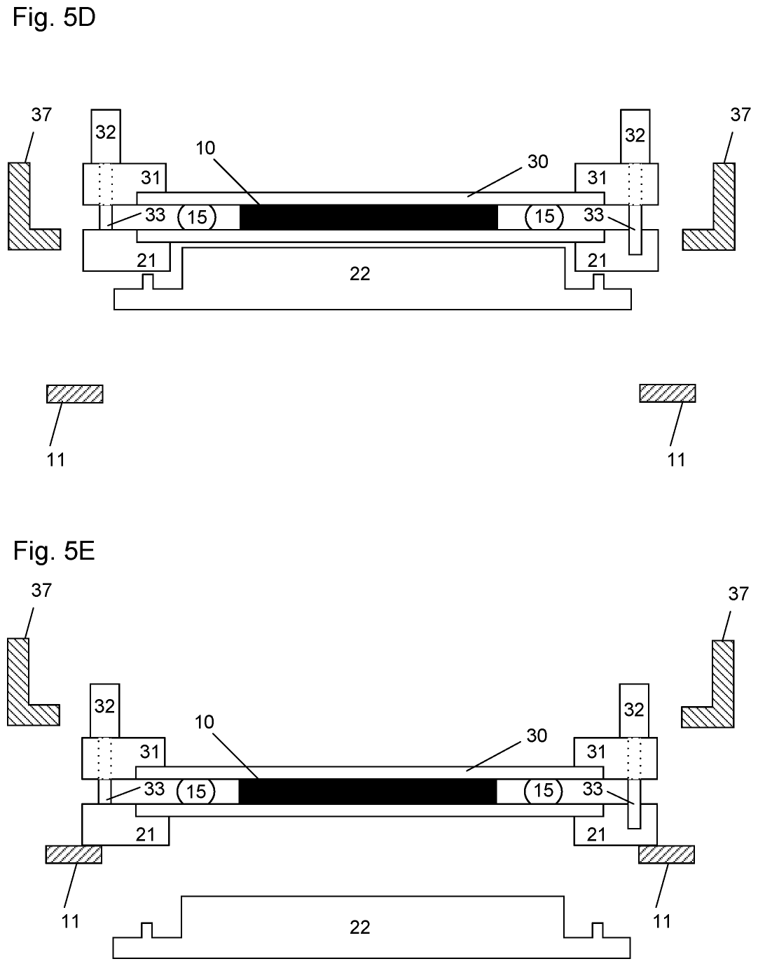

FIGS. 6A to 6B schematically explain the arrangement of the stations on a conveying device; and

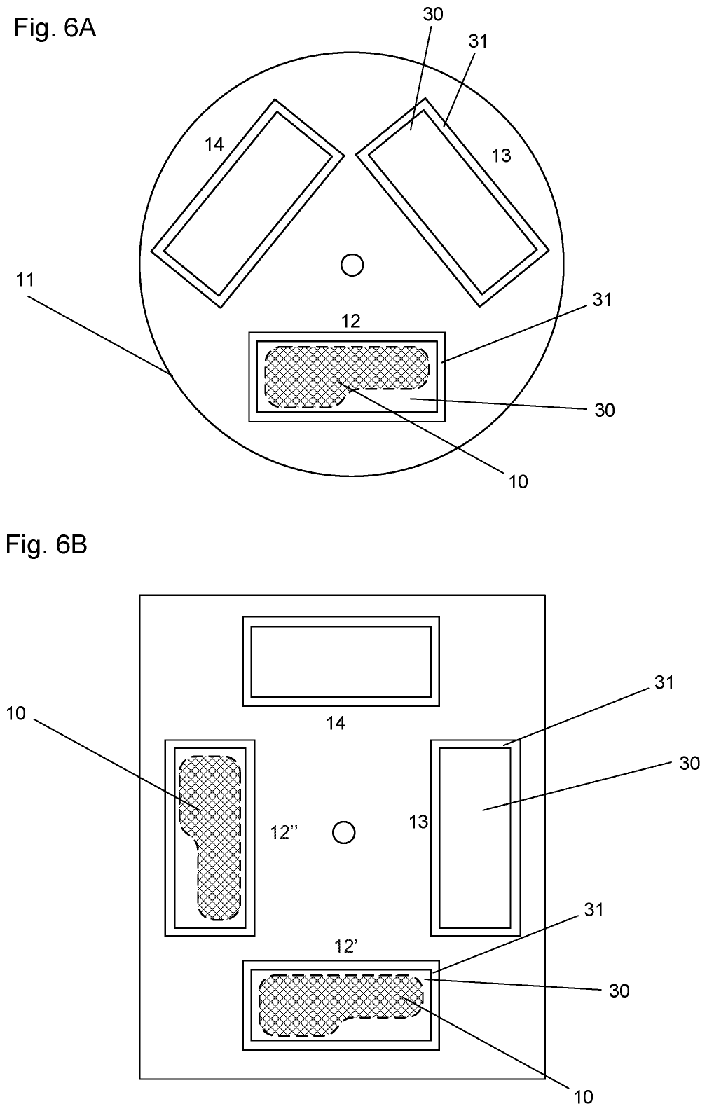

FIGS. 7A and 7B schematically explain a method for consolidating a fiber composite structure having an elevation, according to another preferred embodiment; and

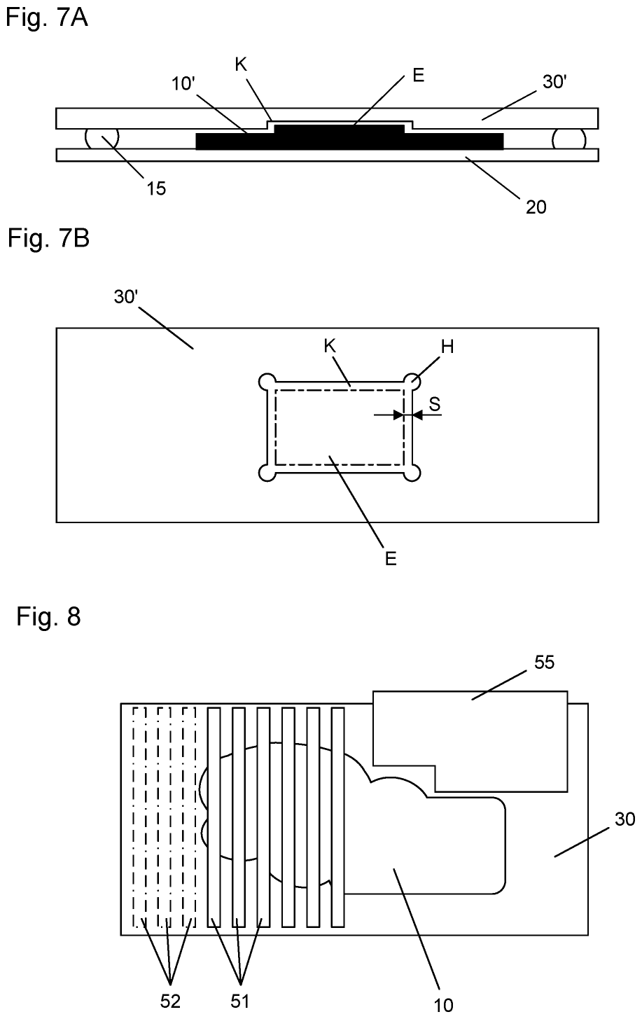

FIG. 8 illustrates the composition of a radiation source and the heating of a fiber composite structure.

With reference to FIGS. 2A to 2E, first, a method for consolidating a fiber composite structure according to a first preferred embodiment will be described.

As is shown in FIG. 2A a fiber composite structure 10, which is preimpregnated with thermoplastic or thermoelastic polymers or mixed with such polymers in a solid, or dissolved, or deposited state, is arranged on a plate-shaped base 20. With the provision of a sealing element 15, in particular an elastic annular seal which surrounds the fiber composite structure 10 laterally and preferably at a distance, a plate-shaped cover 30 is further positioned over the fiber composite structure arranged on the base 20. The base 20 and the cover 30 are each formed of a heat-resistant material that allows electromagnetic radiation, in particular infrared radiation, to pass. Particularly preferably, the base 20 and the cover 30 are each designed as glass panels. For example, the cover 30 and the base 20 may each be designed as rectangular glass panels having a width of 500 mm, 1000 mm, 1500 mm, 2000 mm or more, and a length of 1000 mm, 1500 mm, 2000 mm, 2500 mm or more. The thickness of the glass panel can be, for example, 2 mm, 3 mm, 5 mm or more.

So as to prevent the base 20 from sagging downwardly by virtue of its own weight, it is preferably provided that the base 20 is support from below, for example by being placed partially or across the entire surface area on a table top or on another support structure (not shown) which supports the base 20 from below. It is likewise conceivable to design the base 20 to have a greater thickness than the cover 30, for example to use a glass panel measuring 5 mm or 8 mm for the base 20, while a glass panel measuring 2 mm or 3 mm is used for the cover 30. In this case, the base 20 will have inherently greater rigidity and, accordingly, will tend to deflect less than the cover 30.

So as to provide easier handling of the cover 30 and the base 20, these can each be fastened to a support frame. The support frame can have a one-piece or multi-piece design, and can surround the cover 30 and the base 20 completely or partially at the side edges thereof. Correspondingly, FIG. 2A shows, by way of example, that two support frame elements 21 and 31 are arranged on the cover 30 and the base 20, respectively. An example of a support frame composed of support frame elements 31 which completely surrounds or encloses the cover 30 can be seen in FIG. 2E, which shows a top view from above of an exemplary cover 30. Lateral projections, recesses or the like (not shown) can be provided on the support frame elements 31 for handling the cover 30, in particular for positioning the cover 30 over the base 20, which allow corresponding hooks or other holding elements (not shown) to engage in the support frame 31 and thus in the cover 30. If a glass panel is used for the cover 30 and/or the base 20, the glass panel can, for example, be fixedly connected to the corresponding support frame elements 21, 31 by adhesive bonding. Other types of fastening, such as screwing, or also clamping in a groove provided in a support frame element 21, 31 and which surrounds and clamps the glass panel on both sides, are likewise conceivable.

Again with reference to FIG. 2A, actuators 32, in particular pneumatic actuators, are arranged on the support frame elements 31 arranged on the cover 30, the actuators being activatable using a preset pressure to extend a respective cylinder 33 to a predefined stroke limit. Via the cylinders 33, which are braced on the support frame elements 21 arranged on the base 20, the actuators 32, in particular the pneumatic actuators, can thus position and hold the support frame elements 31 arranged on the cover 30 at a predefined height over the support frame elements 21 arranged on the base 20. The actuators 32, together with the cylinders 33, can therefore be regarded as a bracing device, which braces the cover 30 with respect to the base 20. The force of all actuators 32, in particular of the pneumatic actuators, is greater than the weight exerted as dead weight of the cover 30 and the support frame elements 31. In this way, by applying the preset pressure to the pneumatic actuators, the cover 30 can be held and/or positioned in a predefined position over the base 20 and the fiber composite structure 10 arranged on the base 20.

In this position, it can advantageously be provided that the cover 30 is located at a height of 2 to 20 mm above a target thickness when consolidation is completed, and/or the cover 30 is located at a height of at least 0.1 mm, preferably at least 1 mm, more preferably at least 3 mm, and particularly preferably at least 5 mm above the surface of the fiber composite structure 10. It should be taken into account here that the cover 30 in this position can undergo inherent flection by virtue of the dead weight thereof and only lateral retention by the support frame elements 31. The degree of this inherent flection is essentially determined by the selection of the material of the cover 30, particularly the stiffness and specific weight thereof, as well as the thickness, width and length of the cover 30. Particularly preferably, the material and the thickness of the cover 30 are selected in such a way that the inherent flection is in a range between 2 and 20 mm, preferably in a range between 3 and 15 mm, particularly preferably in a range between 5 and 10 mm. Correspondingly, the cited height information is to be understood in this case as height information with respect to the deepest point of the bottom surface of the cover 30. FIG. 2A shows further radiation sources 14 which are arranged above the cover 30 and beneath the base 20 and which are configured to emit electromagnetic radiation for heating the fiber composite structure 10. Alternatively, it is likewise possible to arrange only one radiation source 14 above the cover 30 or beneath the base 20. The radiation sources 14 are preferably implemented as infrared light sources. The radiation source 14 arranged beneath the base 20 can optionally also be arranged in the support structure (not shown) for the base 20. The radiation sources 14 are preferably designed as panel heaters, which irradiate the cover 30 and/or the base 20 essentially across the entire surface area and with substantially uniform surface radiation density. It shall be noted that in the following FIGS. 2B to 2D the radiation sources 14 are not shown for the sake of clarity.

The interstice sealed by the cover 30, the base 20 and the sealing element 15 is then evacuated with the aid of a pump or the like (not shown) so that a negative pressure arises in the interstice. Due to the pressure difference arising on the cover 30 between ambient pressure, on the one hand, and negative pressure in the interstice, on the other, a compressive force arises on the cover 30, as is illustrated by the arrow in FIG. 2B. Since the cover 30 is held at the lateral edges (here, for example, the edges in the longitudinal direction of the cover 30, 30′) by the support frame elements 31, and these are held in position at a height by means of the actuator 32 and the cylinders 33, the compressive force exerted on the cover 30, together with the dead weight of the cover 30, results in flection of the cover 30, so that the cover curves downwardly, as is also schematically illustrated in FIG. 2B.

With increasing negative pressure, the force exerted on the cover 30 will increasingly grow, so that the cover 30 will increasingly deflect and will rest first on the fiber composite structure 10 in the center. In other words, the cover 30 only makes contact with the fiber composite structure 10 in a relatively small subsection A of the surface of the fiber composite structure 10, as is schematically illustrated in FIG. 2C. As the negative pressure increases, the subsection A will increase, and the boundaries thereof will gradually migrate to the outside.

The cover 30 thus presses, in an increasingly larger region, on the fiber composite structure 10, which has preferably been heated by the radiation sources 14 to such an extent that the thermoplastic or thermoelastic polymers have melted even in the core of the fiber composite structure 10.

As soon as the sum of the weight brought about by the dead weight of the cover 30 and the support frame elements 31 (as well as possibly further support frame elements 31 provided on the cover 30 and/or other elements) and the force exerted on the cover 30 due to the negative pressure, minus the compressive force introduced into the fiber composite structure 10 via the subsection A, exceeds a predetermined level, in particular the level of the maximum lifting force of the actuators 32, in particular of the pneumatic actuators, pressure limiting valves provided on the actuators 32 open. As a result, the support frame members 31 are able to be lowered, as is illustrated by the arrows in FIG. 2C, and the cover 30 bears completely against the base 20 until the cover 30 makes full contact with the fiber composite structure 10, as is shown in FIG. 2D. The support frame elements 21 and 31 can be designed and dimensioned so as to define a stop, which defines the distance between the base 20 and the cover 30 with respect to each other when they are completely closed, thus defining the target thickness of the fiber composite structure 10 to be consolidated. However, it is preferred that the support frame members 21 and 31 are each designed to be flush with the corresponding surfaces of the cover 30 and the base 20, and that a stop delimiting the compression and defining the target thickness of the fiber composite structure 10 is provided in another manner. For example, the minimum stroke limit of the actuators 32, in particular of the pneumatic actuators, can be used as a stop, wherein the actuators 32 are arranged and fastened in a position relative to the support frame elements 31 in such a way that the position defined by the minimum stroke limit of the actuators 32 corresponds to the desired target thickness of the fiber composite structure 10 to be compressed. Alternatively, a separate stop may also be provided, such as a stop element that is arranged between the support frame members 21, 31 and/or between the base 20 and the cover 30 and dimensioned, in terms of thickness, so as to correspond to the target thickness of the fiber composite structure 10 to be compressed.

The compression and consolidation of the fiber composite structure 10 therefore does not take place simultaneously across the entire surface area, as is the case, for example, with the method explained with reference to FIG. 1. Rather, the fiber composite structure 10 is compressed successively and in a controlled manner toward the outside, proceeding from a narrow subsection A, by means of the bent cover 30 so that the displacement of fiber and polymer material, which is caused by the local action of the compressive force exerted by the bent cover 30, causes air trapped in the fiber composite structure 10 or vapors forming as a result of heating, to be pushed out and, after only a relatively short distance, to reach a region in which the cover 30, by virtue of the flection thereof, does not yet, or not yet strongly, push on the fiber composite structure 10, so that the trapped air or vapors forming as a result of heating can escape more easily out of the fiber composite structure 10 into the interstice and be removed via the connected vacuum pump. This makes it possible to consolidate the fiber composite structure 10 substantially without the formation of air inclusions, or with only very small air inclusions or pores, and thus form it into a high-grade laminate of high quality.

Furthermore, it is also conceivable for an identification of bubble formation to be carried out during the compression of the fiber composite structure. For example, a pressure sensor can be used to measure the (negative) pressure predominating in the interstice, which can be evaluated by the control unit. If a rapid increase in pressure is measured, the control unit can rate this as the formation of a bubble, for example by evaporation of liquid. Alternatively or additionally, it can also be provided to detect and evaluate the surface of the fiber composite structure 10 with the aid of a thermographic camera in the form of a thermal image. The control unit can watch for the presence of local hot spots or local cold spots in the thermal image. A local hot spot, that is, a location at which the temperature of the fiber composite structure 10 shown in the thermal image is significantly higher than the temperature in surrounding areas can, for example, indicate the presence of foreign bodies, which heat up more quickly and to a higher temperature than the impregnating polymer under the influence of the electromagnetic radiation. Conversely, a local cold spot, that is, a location at which the thermal image indicates a significantly lower temperature than for surrounding locations, may indicate an air or vapor bubble. The reason is that, when a bubble is present, polymer and fiber material is displaced by the bubble. Since hot polymer and fiber material emits more infrared radiation, which is detected by the thermographic camera, than a vapor or air bubble (even if it has the same temperature), the thermal image will therefore appear darker in this area.

In this way, the control unit can cause the vacuum pump to be throttled so that the pressure in the interstice increases, and less negative pressure prevails, when the control unit detects bubble formation. The cover 30 will therefore bend less, and the subsection A in which the cover 30 is supported on the fiber composite structure 10 will become narrower. Concurrently or alternatively, the control unit can also actuate the actuators 32, in particular the pneumatic actuators, to extend the cylinders 33 further, and thereby lift the cover 30 on the sides, which likewise narrows the subsection A in which the cover 30 is supported on the fiber composite structure 10. In this way, improved ventilation of the fiber composite structure 10, in particular removal of the bubbles, can be ensured.

After the fiber composite structure 10 has been compressed in this way and consolidated to form a laminate, also referred to as a tailored blank, and after the laminate is cooled, the cover 30 can be opened. This can be carried out in a simple manner by switching off the vacuum or the negative pressure in the interstice and lifting off the cover 30. However, it is preferred to proceed in the reverse order compared to the sequence shown in FIGS. 2A to 2D. Thus, if the negative pressure continues to exist in the interstice, the actuators 32, in particular the pneumatic actuators, are charged with compressed air to bend the cover 30. The cover 30 thus curves upwardly at the lateral ends and detaches locally from the consolidated laminate. Afterwards, the negative pressure in the interstice is successively reduced so that the cover 30 gradually detaches from the laminate, and the laminate peels off the cover 30 in this way. This has the advantage that the laminate can be separated from the cover 30 more reliably and without destruction.

While above, in particular, the use of pneumatic actuators as bracing units was described, this has no limiting effect, and it is also possible to use other actuators 32 or devices to support the cover 30 with respect the base 20. For example, hydraulic actuators, electromotive actuators or other actuators can also be used as bracing units, in particular also servo actuators, which, under the control of a control unit, make it possible to position the cover 30 in terms of height and/or to exert a predefined force.

The method can preferably be carried out in a system (not shown) for consolidating a fiber composite structure 10 which comprises a loading/unloading station, a pressing station and a cooling station.

In the loading/unloading station, the base 20 can be made accessible, for example, to an operator in such a way that the operator can place a fiber composite structure, such as a tape structure laid in the tape laying method, onto the base 20. The cover 30 is placed on or above the base 20 via a holder provided in the system, which can engage, for example, on the support frame or the support frame elements 31 of the cover 30, so that the fiber composite structure 10 is arranged in the interstice sealed by means of a sealing element 15, as described above with reference to FIG. 2A.

The base 20, together with the fiber composite structure 10 arranged thereon and the cover 30 arranged thereabove, can then be moved to the pressing station in which the fiber composite structure 10 is irradiated and heated by the radiation sources 14, for example to a temperature in the range between 200 and 400° C., depending on the impregnating polymer, until the core of the fiber composite structure 10 is molten. In the pressing station, it can be provided that a lifting table is arranged, which is preferably designed with a flat table surface, to lift the base 20 off a conveying device (not shown), which ensures the transport in the system, and thus bring it into a well-defined position. Afterwards, the vacuum is built up in the interstice, and the compression is carried out as described in more detail in FIGS. 2B to 2D.

After compression has taken place, the entirety of the base 20, the cover 30 and fiber composite structure 10 pressed therebetween is moved to the cooling station, preferably while a vacuum continues to be applied.

A cooling table can be provided in the cooling station, onto which the base 20 is placed or which can be lifted so as to be brought in contact with the base 20. Likewise, a cooling device may be provided which is brought in contact with the cover 30 from above. Alternatively, the cooling table can lift the base 20 until the cover 30 is brought in contact with the cooling device. By means of the cooling table and the cooling device, the cover 30 and the base 20, and indirectly the fiber composite structure 10, are cooled, for example, until the fiber composite structure 10 is cooled at the core to a temperature below 150° C., preferably below 100° C., and the impregnating polymer solidifies.

Thereafter, the entirety of the base 20, the cover 30 and the fiber composite structure 10 pressed therebetween can be moved to the loading/unloading station in which the cover 30 is lifted off, and the operator can remove the fiber composite structure fully consolidated to form the laminate.

With reference to FIGS. 3A to 3C, a second embodiment of the invention will now be described. The second embodiment essentially differs from the first embodiment in that spring elements 35 are provided instead of the actuators 32 used in the first embodiment. The spring elements 35 are preferably mounted in the support frame elements 31 of the cover 30 and, due to the inherent spring force, support the cover 30 with respect to the base 20 or the support frame elements 21 of the base 20. The spring elements 35 can be designed as simple springs. However, it is preferred that the spring elements 35 are designed with degressive spring characteristics. In this way, it can be achieved that, in the event of initial loading of the spring elements 35, in this case as a result of the increasing negative pressure in the interstice, only slight compression of the spring elements 35 takes place initially, so that, as is shown in FIG. 3B, the cover 30 again undergoes flection, which causes the cover 30 in the narrow portion A to rest on and be braced against the fiber composite structure 10. With increasing negative pressure, and thus increasing loading of the spring elements 35, the spring elements 35 reach the region of a flatter gradient of the degressive spring characteristic, so that the spring elements 35 undergo increasingly greater compression and, accordingly, the lateral ends of the cover 30 are increasingly lowered. The subsection A, in which the cover 30 is supported on the fiber composite structure 10, therefore increasingly grows in width until the cover 30 is ultimately in contact across the entire surface area with the fiber composite structure 10 and compresses the same, as is shown in FIG. 3C. Here as well, it can preferably again be provided that a control unit activates the vacuum pump in such a way that a desired chronological progression of the (negative) pressure in the interstice is set, so as to control and/or regulate a desired progression of the flection of the cover 30, and thus a desired progression of the compression, taking into account the spring characteristics of the spring elements 35.

So as to avoid excessive compression of the fiber composite structure 10, as is further shown in FIGS. 3A to 3C, it can preferably be provided to provide stop pieces 36 between the cover 30 and the base 20 and/or between the corresponding support frame elements 31, 21. The stop pieces 36 are dimensioned in the height thereof to correspond to the target thickness of the consolidated fiber composite structure 10. The stop pieces 36 can be made of a metal, for example. However, the stop pieces 36 are preferably formed of a temperature-resistant plastic material, in particular having low specific heat capacity. This has the advantage that these stop pieces 36 likewise cool rapidly when the fiber composite structure 10 is cooled, and there is no resulting effect that the stop pieces 36 remain hot beyond the cooling process and, when the next fiber composite structure 10 is introduced, this is heated prematurely and undesirably locally, which could lead to uneven compression and consolidation. The stop pieces 36 can be arranged between the fiber composite structure 10 and the sealing element 15. Alternatively and preferably, these stop pieces can also be arranged downstream of or behind the sealing element 15 to respond flexibly and quickly to a changed target thickness of the fiber composite structure, without paying particular attention to the sealing element 15 since this can remain at its location.

A third embodiment of the invention is described in FIGS. 4A and 4B. As shown, spacers 40 are provided in this embodiment, which are arranged between the base 20 and the cover 30 and/or optional corresponding support frame elements (not shown in FIGS. 4A and 4B). The spacers 40 can, for example, be fixedly connected to the base 20. The spacers 40 have a height corresponding to the target thickness of the fiber composite structure 10 to be consolidated, in addition to a small oversized dimension, preferably in the range between 0.1 and 0.5 mm. The spacers 40 can likewise be formed of metal or preferably of a temperature-resistant plastic material, in particular having low specific heat capacity. The spacers 40 are preferably arranged at a distance between 20 and 200 mm from the outer edge of the fiber composite structure 10.

As is shown in FIGS. 4A and 4B, the spacers 40 likewise have the effect of supporting the cover 30, so that the cover 30 is again bent under the action of the negative pressure in the interstice.

With reference to FIGS. 5A to 5E, a further embodiment of the invention will now be shown. In particular, a situation such as can be found in the loading/unloading station 12 is illustrated here. A fiber composite structure 10 is arranged on the base 20, which is embedded in support frame elements 21. The base 20 or the support frame elements 21 are situated on the conveying device 11 which in this area has a cut-out through which a lifting table 22 can be moved in the direction of the conveying device 11. The cover 30, held in the support frame elements 31, is arranged at a distance above the base. The cover 30 or the support frame elements 31 are held at a distance from the base 20 by a plurality of holding elements 37 to allow the fiber composite structure to be placed onto the base 20 and/or the sealing element 15 to be inserted. The holding elements 37 hold the cover 30 or the support frame elements on isolated points or surface areas, but preferably not peripherally across the entire surface area. After the fiber composite structure 10 and the sealing element 15 have been deposited on the base 20, the lifting table 22 is displaced in the direction of the conveying device 11 and lifts the base out of the conveying device 11, as shown in FIG. 5B. The lifting table 22 is displaced in the direction of the cover 30 until the cylinders 33 make contact with the support frame elements 21, or until the sealing element 15 is in contact both with the cover 30 and with the base 20 and forms an interstice which can be evacuated by means of a vacuum pump. The cover 30 and the base 20 can also be moved horizontally with respect to one another by the lifting table 22 and the holding elements 37, whereby the cover 30 can be optimally aligned with respect to the base 20. Due to the resulting negative pressure in the interstice between the cover 30 and the base 20, the base 20 and the cover 30 move the base 20 and the cover 30 toward one another. Furthermore, the weight of the cover 30 and the force resulting from the negative pressure in the interstice create a force-fit connection between the base 20 and the cover 30 via the cylinders 33 and the sealing elements 15, whereby the cover 30 can be detached from the holding elements 37 and now rests on the support 20. The cover 30 and the base 20 are also fixed in the their position with respect to one another by the force-fit connection and cannot be displaced with respect to one another.

As the cover 30 increases the contact area thereof with the fiber composite structure 10 due to the negative pressure in the interstice between the cover 30 and the base 20, the lifting table can move the arrangement composed of the base 20, the fiber composite structure 10 and the cover 30 downwardly in the direction of the conveying device 11. The cover 30 can also already rest completely on the fiber composite structure 10, as is illustrated in FIG. 5D. The cover 30 should preferably be in nearly complete contact with the fiber composite structure 10 when the lifting table 22 deposits the arrangement composed of the base 20, the fiber composite structure 10 and the cover 30 on the conveying device 11, as is illustrated in FIG. 5E. After having deposited the arrangement, the lifting table 22 can be moved out of the effective range of the conveying device 11 so that, in the present case, the arrangement composed of the base 20, fiber composite structure 10 and cover 30 can be moved from the loading/unloading station 12 to the next station, that is, the heating station 13, so as to be heated there to a temperature preferably above the melting temperature of the at least one thermoplastic polymer.

In a further embodiment, the lifting table 22 could also be equipped with a radiation source 14, in particular with infrared tubes 51, 52, and a procedure as is described in FIGS. 5A to 5E could be carried out, and in the heating station 14, after the fiber composite structure 10 has been deposited on the base 20. The fiber composite structure 10 would be heated by the lifting table 22, comprising the integrated radiation source 14, from the side of the base 20. Furthermore, a further radiation source, as is shown in FIG. 4A, for example, could be arranged in the heating station 14 above the cover 30. The holding elements 37, which hold the cover 30 or the support frame elements 31 on isolated points or surface area, do not interfere, since they are arranged outside the effective range of the radiation source.

Alternatively, as described above, the lifting table 22 could also be used in a cooling station 14, wherein it would then preferably be equipped with a cooling unit, in particular a surface cooling system. The lifting table 22 could move the arrangement composed of the base 20, the fiber composite structure 10, and the cover 30 in the direction of a further cooling unit, which can cool the fiber composite structure 10 via the cover 30.

FIGS. 6A and 6B schematically illustrate two embodiments for arranging the various stations for the consolidation of a fiber composite structure 10. The loading/unloading station 12, the heating station 13 and the cooling station 14 are preferably arranged on a conveying device 11 designed as a rotary table, which is mounted so as to be rotatable about a center of rotation. The respective units, such as radiation sources 14 or cooling unit, are arranged in a stationary manner at the individual stations, and the conveying device 11 moves the arrangement composed of the base 20, the fiber composite structure 10 and the cover 30 to the respective stations. The conveying device 11 preferably has a cut-out, on the edge of which the support frame elements 21 of the base 20 can rest. Due to the cut-outs, it is possible, for example, for a lifting table 22 to pick up the base 20 out of the conveying device 11, or for the fiber composite structure 10 to be heated or cooled in the heating station 13 or the cooling station 14 via the cover 30 and the base 20.

Alternatively, the loading/unloading station 12 can also be divided into two separate units, as in FIG. 6B, so that the conveying device 11 comprises a loading station 12′ and an unloading station 12″. This arrangement may be useful when loading and unloading of the fiber composite structure 10 represent a bottleneck in terms of the cycle time. In particular in the case of fiber composite structures that have a low target thickness and therefore heat and cool rapidly, the division of the loading/unloading station 12 into a loading station 12′ and an unloading station 12″ can further increase the cycle time for consolidating the fiber composite structure 10, and thus also the throughput through such a system.

The above-described embodiments are in particular suitable for compressing and consolidating flat fiber composite structures 10, that is, fiber composite structures 10 having a substantially uniform thickness. For an increasing number of uses and areas of application of fiber-reinforced components, however, there is the requirement that these components should have local reinforcements, for example in component regions to which later hinges are to be attached or which are to be connected to other components. For such applications, the fiber composite structures 10 are already laid with corresponding locally reinforced sections, for example in the form of tailored blanks formed in the tape laying process. So as to compress such locally reinforced fiber composite structures 10 provided with elevations and consolidate these to form a laminate, it is provided in a further preferred embodiment, as shown in FIGS. 7A and 7B, to use an adapted cover 30′.

FIG. 7A schematically shows a fiber composite structure 10′, which here, by way of example, comprises a locally reinforced section having an elevation E in a central region. It is further provided for the cover 30′ to be designed with a cavity K corresponding to the elevation E. The cavity K in the cover 30′ can be formed, for example, by milling. In FIG. 7B, which shows a view of the cover 30′ from beneath, it is apparent that the cavity K surrounds the elevation E with a circumferential gap S. The gap S preferably has a width between 3 and 15 mm, particularly preferably between 5 and 10 mm. By providing such a gap S, a free flow channel is provided, via which, under the action of the negative pressure and by means of the vacuum pump (not shown), air trapped in the fiber composite structure 10′, in particular in the region of the elevation E, or vapors forming due to heating can be suctioned off and discharged.

The free flow and discharge of air and vapors is supported in particular by the flection of the cover 30, as described above, which can ensure that the gap S toward one side of the cover 30 does not come in contact with the surface of the fiber composite structure 10′ until a late point in time, and thus it is closed, at which point in time substantial extraction by suction has already taken place for the region of the elevation E. Alternatively or additionally, active ventilation of the gap S can also be provided, for example by temporarily increasing the pressure in the interstice or by reducing the vacuum, and/or by raising the cover 30′ to achieve an at least partial reduction in the contact of the cover 30′ with the fiber composite structure 10′ and thus allow venting of the gap S. It may likewise be considered to provide a venting channel, which can be incorporated into the surface of cover 30′ in the form of a narrow groove, for example, or in the form of a borehole extending through cover 30′ and likewise connected to the vacuum pump. Other types of venting the gap S are also conceivable.

As is apparent from FIGS. 7A and 7B, the fiber composite structure 10′ and the cover 30′ form substantially complementary geometries, so that the overall geometry of the base 20, fiber composite structure 10′ and cover 30′ has a substantially plate-like shape having a constant thickness.

The advantage is exploited that, in particular, a cover 30; designed as a glass panel has a substantially similar heat capacity as the materials customarily used in fiber composite structures 10′. For this reason, given an uniform surface radiant power of the radiation sources 14, the locally reinforced section of the elevation E, that is, the thicker section of the fiber composite structure 10′, can be thoroughly heated in the same time as the thinner areas of the fiber composite structure 10′, due to the thinner glass layer of the cover 30′ in this area.

The cavity K is preferably designed undersize to compensate for the shrinkage of the material as a result of the consolidation.

As is further apparent in FIG. 7B, the cavity K is preferably designed with undercut corner radii H, so that it is also possible to process elevations E having sharp-edged corners. This is, in particular, advantageous when the fiber composite structures to be compressed and consolidated are formed by a tape laying process, in which rectangular tape sections are usually processed and laid to form a desired fiber composite structure.

The cover 30′ provided with a cavity K can suitably be used as a cover 3 or 30 in the methods for consolidation described and/or mentioned herein, so as to suitably enable the described methods to consolidate fiber composite structures 10, 10′ having differences in elevations.

With reference to FIG. 8, furthermore an exemplary embodiment of the radiation sources 14 will be explained. As is shown in FIG. 6, the radiation sources 14 preferably comprise a plurality of infrared tubes 51, 52 that extend transversely to the cover 30 or the base 20. The infrared tubes 51, 52 are preferably designed and arranged to generate a uniform surface radiant power so as to allow the fiber composite structure 10 to be heated as uniformly as possible. Particularly preferably, it is provided that the infrared tubes 51, 52 can be selectively switched on individually or in groups, so that only necessary areas are irradiated, depending on the size, shape and position of the fiber composite structure 10. For example, in the example of FIG. 6, the infrared tubes 52 extending across the fiber composite structure 10 can be switched on, while the infrared tubes 51 that do not overlap the fiber composite structure 10 remain switched off This can be used for saving energy, and thus for lowering costs. It can likewise be provided that, in regions in which irradiation with infrared light is only partially needed or desired, a screen element 55 is provided to prevent the cover 30 or the base 20 from being irradiated and heated in this region in which no proportion of the fiber composite structure 10 is located, or the upper and lower radiation sources 14 from mutually heating one another on their own through the cover 30 and the base 20 in this region, due to the absent fiber composite structure 10, and thereby expose one another to thermal loading and possibly premature aging.

### LIST OF REFERENCE SIGNS P1547

1, 10, 10′ fiber composite structure

2, 20 base

3, 30, 30′ cover

4, 14 radiation source

5, 15 sealing element

6 pipe socket

11 conveying device

12, 12′, 12″ loading/unloading station

13 heating station

14 cooling station

21 support frame element

22 lifting table

31 support frame element

32 actuator

33 cylinder

35 spring element

36 stop piece

37 holding element

40 spacer

51, 52 infrared tubes

55 screen element

A subsection

E elevation

H corner radius

K cavity

S gap

1. A method for consolidating a fiber composite structure with at least one thermoplastic and/or thermoelastic polymer, comprising:
arranging the fiber composite structure between a plate-shaped base and a plate-shaped cover in a loading/unloading station of a conveying device, the cover being sealed with respect to the base by a sealing element so as to be displaceable in relation to the base,
generating a negative pressure in the interstice between the base and the cover so that the ambient pressure pushes the cover against the base, and the fiber composite structure is clamped between the cover and the base;
heating the fiber composite structure by electromagnetic radiation preferably at least into the range of the melting temperature of the at least one thermoplastic and/or thermoelastic polymer in a heating station of the conveying device;
cooling the fiber composite structure in a cooling station of the conveying device; and
removing the consolidated fiber composite structure from the base or removing the base onto which the consolidated fiber composite structure has been placed from the conveyor device.

2. The method according to claim 1, characterized in that the consolidated fiber composite structure is fed to a press, in particular a stamping press, after having been removed from the conveying device.

3. The method according to claim 1, characterized in that, after the fiber composite structure has been arranged on the base, the base is lifted out of the conveying device by a lifting table and moved toward the cover, and/or the cover is held above the conveying device by holding elements and moved toward the base.

4. The method according to claim 1, characterized in that the cover is released from the at least one holding element as soon as a negative pressure is built in the gap between the base and the cover, and the lifting table deposits the arrangement composed of the base, cover and fiber composite structure placed therebetween in the conveying device, preferably in the loading/unloading station.

5. The method according to claim 1, characterized in that an identification of bubble formation is carried out during the compression of the fiber composite structure, in the case of bubble formation, the pressure in the interstice being temporarily increased and/or the cover being lifted to achieve an at least partial reduction in the contact of the cover with the fiber composite structure, and thus enable a local ventilation path for removing the air or vapor.

6. The method according to claim 5, characterized in that the identification of bubble formation takes place by monitoring the magnitude of the negative pressure in the interstice and/or by detecting the temperature distribution in the fiber composite structure by a thermographic camera, the presence of a bubble being inferred when a local cold spot identifiable in the thermal image is present relative to a hot surrounding area.

7. The method according to claim 1, characterized in that the cooling in the cooling station is carried out by way of a self-contained surface cooling system, in particular a cooling table, the surface cooling system being in contact with the base and/or with the cover.

8. The method according to claim 1, characterized in that the surface cooling system is designed as a cooling table which can lift the arrangement composed of the base, cover and fiber composite structure placed therebetween out of the conveying device and supply it to further surface cooling via the cover.

9. The method according to claim 1, characterized in that the fiber composite structure is cooled in the cooling station to a temperature which is below the melting temperature and above the softening temperature of the at least one thermoplastic and/or thermoelastic polymer, or which is below the softening temperature of the at least one thermoplastic and/or thermoelastic polymer.

10. The method according to claim 1, characterized in that the fiber composite structure is cooled in the cooling station to a temperature below 150° C., preferably below 120° C., particularly preferably below 100° C.

11. The method according to claim 1, characterized in that the heating of the fiber composite structure is carried out by electromagnetic radiation before, concurrently with, or after compressing the fiber composite structure between the cover and the base.

12. The method according to claim 1, characterized in that the conveying device is designed to be rotatable.

13. The method according to claim 1, characterized in that the cover and/or the base are designed as or comprise a glass panel.

14. A system for consolidating a fiber composite structure, characterized in that the system comprises a conveying device comprising a loading/unloading station, a heating station and a cooling station, and the system is configured:
to deposit the fiber composite structure on a base in the loading/unloading station, or to introduce a base including a fiber composite structure into the system, and to position a cover over the base and, by a vacuum pump, to generate a negative pressure in the interstice between the cover and the base, and further to move the base and the cover including the fiber composite structure placed therebetween to the heating station;
in the heating station, to heat the fiber composite structure by the at least one radiation source preferably at least into the range of the melting temperature of the at least one thermoplastic and/or thermoelastic polymer and, by the vacuum pump, to maintain or further increase the negative pressure in the interstice to compress the fiber composite structure between the cover and the base;
after compression has been carried out, to move the base (20) and the cover including the compressed fiber composite structure placed therebetween to the cooling station, and to cool the arrangement composed of the base, cover and fiber composite structure placed therebetween in the cooling station; and after cooling has taken place, to move the base and the cover including the fiber composite structure placed therebetween to the loading/unloading station, and in the loading/unloading station, to lift the cover off the base by holding elements to remove the consolidated fiber composite structure from the base, or to remove the base onto which the consolidated fiber composite structure has been placed.

15. The system according to claim 14, further comprising a press, in particular a stamping press.

16. The system according to claim 14, characterized in that the conveying device is designed as a rotary table.

17. The system according to claim 14, characterized in that a lifting table is arranged in the loading/unloading station to move the base together with the fiber composite structure placed thereon away from and toward the conveying device, and/or a holding element is arranged to hold the cover above the conveying device and move it toward and away from the base.

18. The system according to claim 14, characterized in that the system comprises a sensor for detecting the pressure in the interstice and/or a thermographic camera for detecting an image of the temperature distribution in the fiber composite structure, the system further comprising a control unit configured to determine that a bubble is present upon identification of a sudden rise in pressure or a local cold spot identifiable in the thermal image relative to a hot surrounding area and, when a bubble is present, to instruct the vacuum pump and/or the bracing units designed as actuators to temporarily increase the pressure in the interstice and/or lift the cover, so as to achieve an at least partial reduction in the contact of the cover with the fiber composite structure and thus enable a local ventilation path for removing the air or vapor.

19. The system according to claim 14, characterized in that a self-contained surface cooling system, preferably a cooling table, is arranged in the cooling station, which can lift the arrangement composed of the base, cover and fiber composite structure placed therebetween out of the conveying device and deposit it, and which can achieve a cooling effect through the base, and/or a self-contained surface cooling system, preferably a cooling table, is arranged in the cooling station, which can be moved toward the cover and can achieve a cooling effect through the cover.

20. The system according to claim 14, characterized in that the cover and/or the base is designed as or comprises a glass panel.

21. A system for consolidating a fiber composite structure, characterized in that the system comprises a conveying device comprising a loading/unloading station, a heating station and a cooling station, and the system is configured:
to deposit the fiber composite structure on a base in the loading/unloading station, or to introduce a base including a fiber composite structure into the system, and to position a cover over the base and, by a vacuum pump, to generate a negative pressure in the interstice between the cover and the base, and further to move the base and the cover including the fiber composite structure placed therebetween to the heating station;
in the heating station, to heat the fiber composite structure by the at least one radiation source preferably at least into the range of the melting temperature of the at least one thermoplastic and/or thermoelastic polymer and, by the vacuum pump, to maintain or further increase the negative pressure in the interstice to compress the fiber composite structure between the cover and the base;
after compression has been carried out, to move the base and the cover including the compressed fiber composite structure placed therebetween to the cooling station, and to cool the arrangement composed of the base, cover and fiber composite structure placed therebetween in the cooling station; and
after cooling has taken place, to move the base and the cover including the fiber composite structure placed therebetween to the loading/unloading station, and in the loading/unloading station, to lift the cover off the base by holding elements to remove the consolidated fiber composite structure from the base, or to remove the base onto which the consolidated fiber composite structure has been placed,
characterized in that the system is configured to carry out the method according to claim 1.
